(19) United States
(12) Patent Application Publication
(10) Pub. No.: US 2024/0370489 A1
(43) Pub. Date: Nov. 7, 2024

(54) RECOMMENDATION SYSTEM

(71) Applicant: NTT DOCOMO, INC., Chiyoda-ku (JP)

(72) Inventors: Ryoki WAKAMOTO, Chiyoda-ku (JP); Shigeki TANAKA, Chiyoda-ku (JP)

(73) Assignee: NTT DOCOMO, INC., Chiyoda-ku (JP)

(21) Appl. No.: 18/555,560

(22) PCT Filed: Mar. 23, 2022
(86) PCT No.: PCT/JP2022/013734

§ 371 Date: Oct. 16, 2023

(30) Foreign Application Priority Data
May 10, 2021 (JP) 2021-079640

(51) Int. Cl. G06F 16/635; G06F 16/687; G10H 1/36

(52) U.S. Cl. CPC G06F 16/637; G06F 16/687; G10H 1/361

(57) ABSTRACT

A recommendation system is a system determining recommendation information used for giving a recommendation relating to musical pieces to be used to a user and includes: an acquisition unit configured to acquire information representing a remaining time of use of a musical piece; and a determination unit configured to determine the recommendation information on the basis of the information acquired by the acquisition unit.

### TECHNICAL FIELD

The present invention relates to a recommendation system relating to a recommendation relating to a musical piece.

### BACKGROUND ART

Conventionally, it has been proposed to recommend a musical piece to be listened to inside a vehicle such as a private car or the like. For example, in Patent Literature 1, it is described to recommend a musical piece according to a current position of a vehicle, a vehicle speed, and a current time.

### CITATION LIST

### Patent Literature

[Patent Literature 1] Japanese Unexamined Patent Publication No. 2003-84774

### SUMMARY OF INVENTION

### Technical Problem

While a situation in which it is difficult to visit a karaoke parlor due to the Covid-19 pandemic continues, applications and devices for karaoke have become widely spread, the number of facilities for individually performing karaoke inside a private car have increased, and there are various scenes in which karaoke is used. In a case in which karaoke is performed during movement in a private car or the like, a musical piece may be assumed to be recommended to a user using a method disclosed in Patent Literature 1. However, in a case in which a musical piece is recommended in the situation described above or the like, it has been requested to recommend a more appropriate musical piece.

An embodiment of the present invention is in consideration of the situations described above, and an object thereof is to provide a recommendation system capable of giving a recommendation relating to a musical piece that is able to be appropriately used by a user.

### Solution to Problem

In order to achieve the object described above, a recommendation system according to one embodiment of the present invention is a recommendation system determining recommendation information used for giving a recommendation relating to musical pieces to be used to a user and includes: an acquisition unit configured to acquire information representing a remaining time of use of a musical piece; and a determination unit configured to determine the recommendation information on the basis of the information acquired by the acquisition unit.

In the recommendation system according to one embodiment of the present invention, in determination of the recommendation information, the information representing a remaining time of use of a musical piece is used. Therefore, according to the recommendation system of one embodiment of the present invention, a recommendation relating to musical pieces to be used by a user can be appropriately given in accordance with the remaining time.

### Advantageous Effects of Invention

According to one embodiment of the present invention, a recommendation relating to a musical piece able to be appropriately used by a user can be given in accordance with a remaining time.

### BRIEF DESCRIPTION OF DRAWINGS

FIG. 1 is a diagram illustrating the configuration of a recommendation system according to an embodiment of the present invention.

FIG. 2 is a table illustrating an example of information representing a user's singing history transmitted from a user terminal to a recommendation system.

FIG. 3 is a table representing an example of information representing a correspondence relation between a facility name and a genre ID used in a recommendation system.

FIG. 4 is a diagram schematically illustrating a part of a model used by a recommendation system.

FIG. 5 is a diagram schematically illustrating a part of a model used by a recommendation system.

FIG. 6 is a diagram illustrating current place information used by a recommendation system.

FIG. 7 is a flowchart illustrating a process performed by a recommendation system according to an embodiment of the present invention.

FIG. 8 is a diagram illustrating a hardware configuration of a recommendation system according to an embodiment of the present invention.

### DESCRIPTION OF EMBODIMENTS

Hereinafter, a recommendation system according to an embodiment of the present invention will be described with reference to the drawings. In description of the drawings, the same reference signs will be assigned to the same elements, and a duplicate description will be omitted.

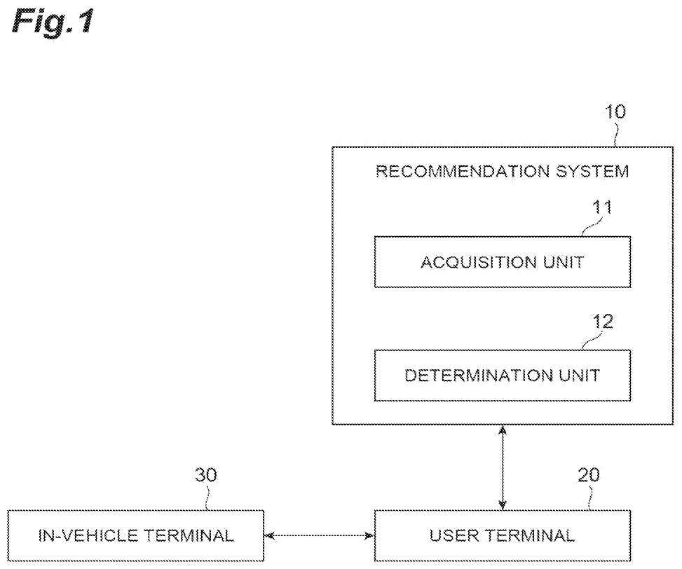

FIG. 1 is a diagram illustrating a recommendation system 10 according to this embodiment. The recommendation system 10 is a system (device) determining recommendation information for giving a recommendation relating to a musical piece to be used to a user. For example, the recommendation system 10 determines recommendation information for recommending a musical piece to be used by a user. The recommendation system 10 gives a recommendation by presenting the determined recommendation information to a user. In other words, the recommendation system 10 presents a recommended musical piece to a user. In addition, the recommendation system 10 may be configured to determine recommendation information for giving a recommendation relating to a musical piece but may not be necessarily determine recommendation information for recommending a musical piece. For example, the recommendation system 10 may be configured to determine recommendation information for recommending a singer singing musical pieces. In such a case, a user can use musical pieces sung by a recommended singer.

For example, the recommendation system 10 determines recommendation information for giving a recommendation relating to a musical piece to be sung by a user at karaoke as a user' use of a musical piece. In addition, as a use other than karaoke, the recommendation system 10 may determine recommendation information for giving a recommendation relating to a musical piece to be used by a user. For example, the recommendation system 10 may determine recommendation information for giving a recommendation relating to a musical piece to which a user listens.

In this embodiment, a user who is a recommendation target may include a group formed from a plurality of users performing karaoke at the same time, for example, a group of users singing in order. In the following description, even in the case of simply referring to a user, the user also includes a group formed from a plurality of users.

In this embodiment, the recommendation system 10 determines recommendation information for giving a recommendation of a musical piece to be sung by a user at karaoke. More specifically, the recommendation system 10 determines recommendation information for recommending a musical piece to be sung by a user at karaoke that is performed inside a vehicle during traveling using a vehicle such as a private car or the like.

The recommendation system 10 is configured using a computer such as a personal computer (PC) having a communication function, a server apparatus, or the like. The recommendation system 10 may be configured using a plurality of computers, that is, a computer system. The recommendation system 10 can transmit/receive information to/from a user terminal (personal terminal) 20 through a network such as a mobile communication network or the like.

The user terminal 20 is a terminal that is used by a user. The user terminal 20, for example, is a smartphone or a tablet terminal (that is, a terminal brought into the inside of a vehicle) carried by a user and is used for a recommendation to the user. The user terminal 20 may be terminal similar to a conventional user terminal. As described above, the user terminal 20 is a front system for the recommendation system 10 that transmits/receives information to/from the recommendation system 10.

In a vehicle used by a user, an in-vehicle terminal 30 is disposed. The in-vehicle terminal 30 has a function of a car-navigation (hereinafter, referred to as a car navigation). The function of the car navigation, as will be described below, is used for determining recommendation information of the recommendation system 10. More specifically, used functions will be described below. In addition, the in-vehicle terminal 30 includes devices used for performing karaoke. For example, the in-vehicle terminal 30 includes a speaker and a microphone. In addition, in-vehicle terminal 30 has functions for performing karaoke such as accepting designation of a musical piece from a user and reproducing the musical piece and the like. The in-vehicle terminal 30 may be similar to a conventional in-vehicle terminal. In addition, a device having the function of the car navigation and a device used for performing karaoke may be independent devices (terminals) that are different from each other.

The user terminal 20 can transmit/receive information thereof to/from the in-vehicle terminal 30 through near field radio communication, wired communication, or the like. The information that is transmitted and received is information relating to a recommendation. In addition, some or all of the functions of the user terminal 20 may be provided in the in-vehicle terminal 30. In a case in which all the functions of the user terminal 20 are provided in the in-vehicle terminal 30, the user terminal 20 does not need to be used. To the contrary, some or all of the functions of the in-vehicle terminal 30 may be provided in the user terminal 20. In a case in which all the functions of the in-vehicle terminal 30 are provided in the user terminal 20, the in-vehicle terminal 30 does not need to be used.

Subsequently, functions of the recommendation system 10 according to this embodiment will be described. As illustrated in FIG. 1, the recommendation system 10 is configured to include an acquisition unit 11 and a determination unit 12.

The acquisition unit 11 is a functional unit that acquires information representing a remaining time of the use of a musical piece. The acquisition unit 11 may acquire information representing a place at which a musical piece is used. The acquisition unit 11 may acquire an image corresponding to a place as information representing a place at which a musical piece is used. The acquisition unit 11 may acquire information representing a point of interest (POI) corresponding to a place as information representing a place at which a musical piece is used. The acquisition unit 11 may acquire information representing a destination of a user using a musical piece. The acquisition unit 11 may acquire information that represents a user's use history of a musical piece.

Information acquired by the acquisition unit 11 is information that is used for determining recommendation information in the recommendation system 10. The acquisition unit 11 acquires each piece of information as below. More specifically, the car navigation of the in-vehicle terminal 30 has the following functions. The car navigation measures a position of a vehicle in which the in-vehicle terminal 30 is mounted. In addition, the car navigation receives a destination from a user as an input and calculates a route from a position of a vehicle acquired through position measurement to a destination. Furthermore, the car navigation calculates a required time from a current time point at the time of moving to a destination through the calculated route. The car navigation presents the route and the required time that have been calculated to the user.

The user terminal 20 acquires the following information acquired using the function of the car navigation from the in-vehicle terminal 30. More specifically, the user terminal 20 acquires information representing the position of the vehicle acquired through position measurement as information representing a place at which a musical piece is used. The information representing a position of a vehicle, for example, is information representing a latitude and longitude of a current place. In addition, the user terminal 20 acquires information representing a destination as information representing a destination of a user using a musical piece. The information representing a destination is information representing a name of a destination (for example, a facility name) or latitude and longitude of the destination. In addition, the user terminal 20 acquires information representing a time required to reach a destination as information representing a remaining time of the use of the musical piece. The information representing a required time up to a destination is information in units of hours or in units of minutes. In addition, information other than that described above may be used as long as it is information representing a remaining time.

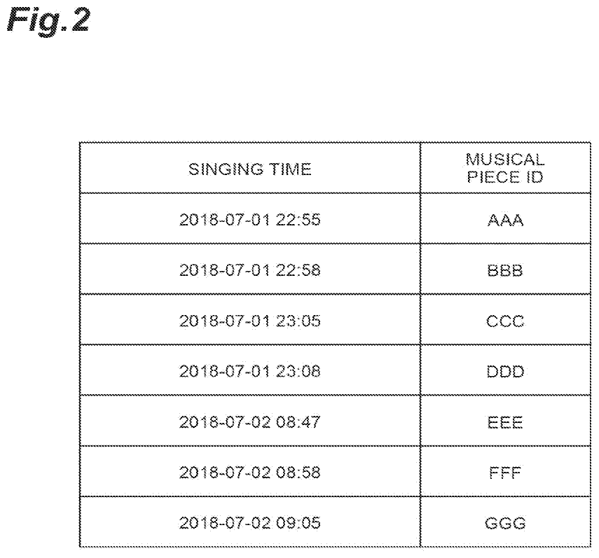

The user terminal 20 acquires the following information relating to the function of performing karaoke of the in-vehicle terminal 30 from the in-vehicle terminal 30. More specifically, the user terminal 20 may acquire information representing a user's singing history as information representing a user's use history of musical pieces. An example of the information representing a user's singing history is illustrated in FIG. 2. This information associates a singing time and a musical piece ID with each other. The singing time is information representing a time at which a musical piece was used (sung) (for example, year, month, date, hour, and minutes as illustrated in FIG. 2). The musical piece ID is a musical piece ID of a used (sung) musical piece. The musical piece ID is information (an identifier) that is used for identifying each musical piece set in advance.

The user terminal 20 transmits the above-described information acquired from the in-vehicle terminal 30 to the recommendation system 10. In addition, the user terminal 20 may acquire information used for determining recommendation information in the recommendation system 10 not from the in-vehicle terminal 30 but a user's input operation or the like. The acquisition unit 11 receives and acquires information transmitted from the user terminal 20.

The acquisition unit 11 may further generate and acquire information used for determining recommendation information from information received from the user terminal 20. For example, the acquisition unit 11 may acquire an image corresponding to a place from the information representing the position of the vehicle described above as information representing a place at which a musical piece is used. More specifically, the acquisition unit 11 stores data of an image of a map in advance and acquires an image of a map of a range having the position of the vehicle as its center set in advance as an image corresponding to a place.

In addition, for example, the acquisition unit 11 may acquire information representing a POI (for example, a building or a sports facility that is a landmark) corresponding to a place from the information representing the position of the vehicle described above as information representing the place at which a musical piece is used. More specifically, the acquisition unit 11 stores information representing a position (for example, latitude and longitude) of a POI in advance, determines a POI that is the closest to the position of the vehicle on the basis of this information, and acquires information representing the POI corresponding to a place.

In addition, for example, as information representing a place at which a musical piece is used, from the information representing the position of the vehicle described above, the acquisition unit 11 may acquire information representing a mesh (for example, a mesh ID) including this position. A mesh is acquired by partitioning a region into rectangles. More specifically, the acquisition unit 11 stores a correspondence relation between a mesh and a position in advance and, from information representing a position of the vehicle, acquires information representing a mesh including this position on the basis of this correspondence relation.

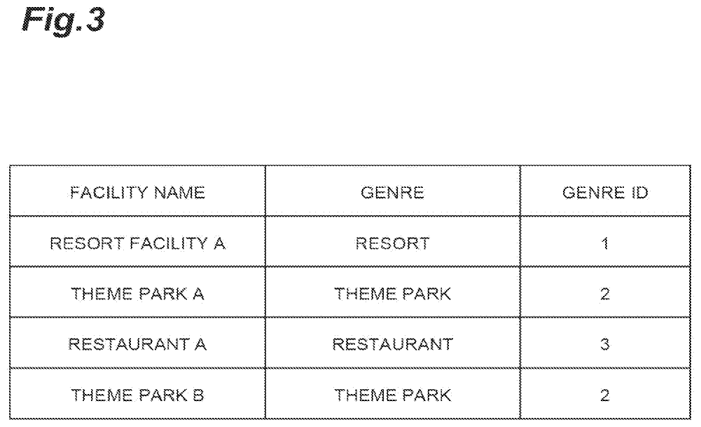

In addition, for example, the acquisition unit 11 may acquire information representing a genre of a destination (for example, a genre ID) from the information representing the destination described above as information representing a destination of a user using a musical piece. For example, genres of a destination are a resort, a theme park, and a restaurant. For example, the genre ID described above is information (identifier) that identifies each genre set in advance. More specifically, the acquisition unit 11 stores a correspondence relation between information representing a destination and a genre ID in advance. An example of the information representing this correspondence relation is illustrated in FIG. 3. The acquisition unit 11 acquires a genre ID relating to a destination from information (for example, a facility name) representing the destination described above on the basis of this correspondence relation.

For example, acquisition of information using the user terminal 20 and transmission of the information to the recommendation system 10 are performed with being triggered upon a predetermined operation using the user terminal 20. The predetermined operation is an operation indicating reception of a reminder of a musical piece to be sung by a user. In that case, the acquisition unit 11 acquires information when a user desires to receive a reminder of a musical piece to be sung by a user. Here, a timing of acquisition of information using the acquisition unit 11, that is, a timing of acquisition of information using the user terminal 20 and transmission of the information to the recommendation system 10 is not necessarily limited to that described above and may be an arbitrary timing. In addition, the acquisition unit 11 may acquire information used for determining recommendation information using a method other than that described above. The acquisition unit 11 outputs the acquired information to the determination unit 12.

The determination unit 12 is a functional unit that determines recommendation information on the basis of information acquired by the acquisition unit 11. The determination unit 12 may determine recommendation information by excluding candidates of recommendation information on the basis of information representing a user's use history of musical pieces. The determination unit 12 determines recommendation information as below.

The determination unit 12 determines recommendation information for recommending a musical piece to be sung by a user at the time point at karaoke on the basis of the information acquired by the acquisition unit 11. For example, the determination unit 12 determines recommendation information using a model that receives information acquired by the acquisition unit 11 as an input and outputs information representing a musical piece to be recommended. The determination unit 12 stores a model in advance.

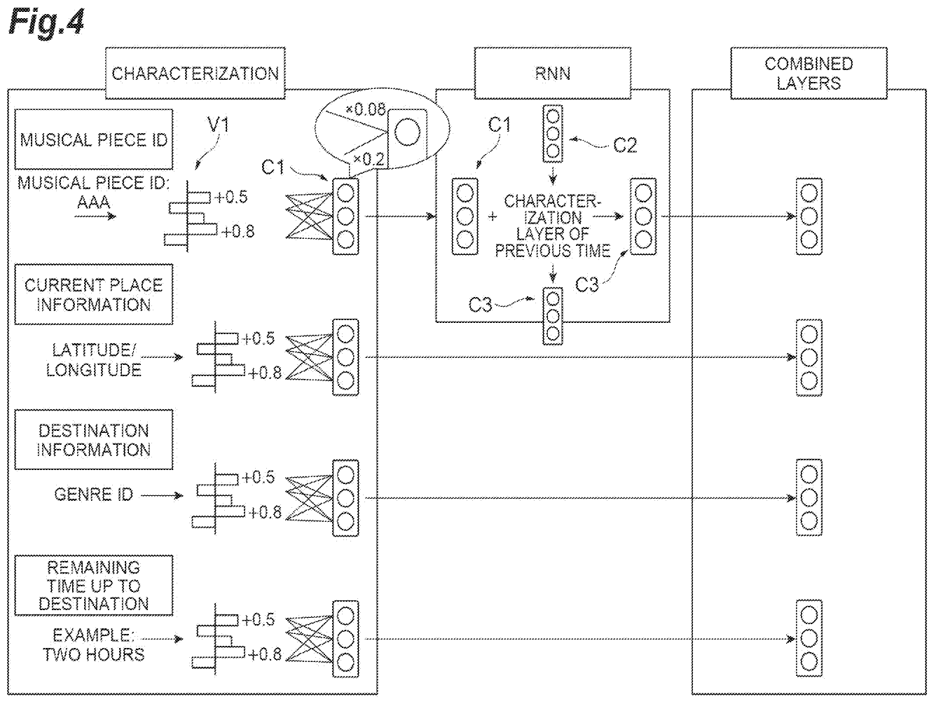

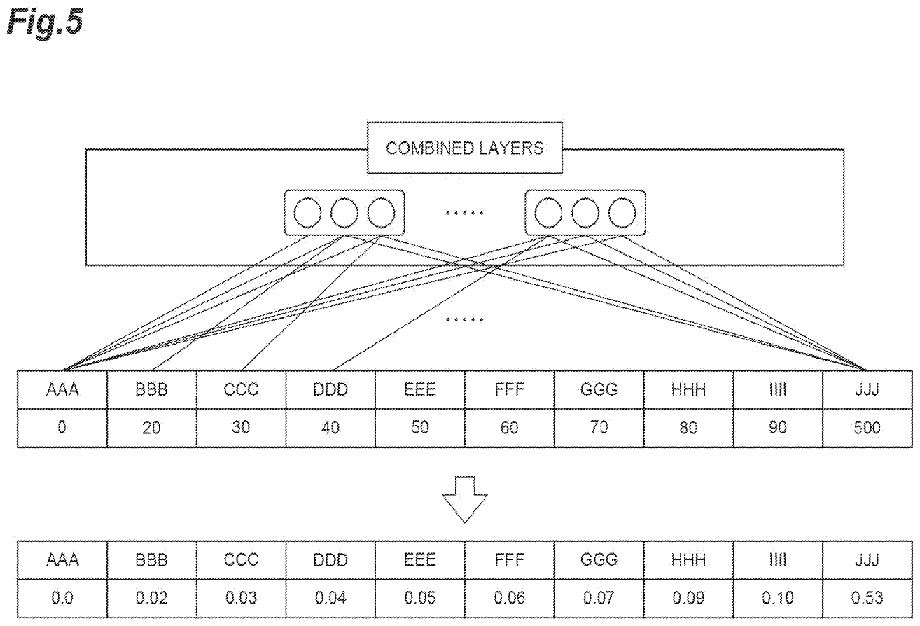

FIGS. 4 and 5 schematically illustrate a model (algorithm). As illustrated in FIG. 4, this model is a model to which information including a musical piece ID, a current place information, destination information, and information of a remaining time up to a destination is input. In addition, as illustrated in FIG. 5, this model is a model that outputs information of a musical piece to be recommended to a user. For example, this model is configured to include a neural network generated through machine learning. The neural network may be a multi-layer network, in other words, may be generated by performing deep learning.

The determination unit 12 receives information from the acquisition unit 11 as an input. The determination unit 12 determines recommendation information by inputting input information to a model and acquiring information output from the model. As illustrated in FIG. 4, a musical piece ID input to the model is a musical piece ID included in a user's singing history. The musical piece IDs are input to the model in order of the oldest to newest singing time. The current place information input to the model is information representing a position of the vehicle (for example, the information representing latitude and longitude described above). The destination information input to the model is a genre ID. The information of a remaining time up to a destination input to the model is information representing a required time up to the destination.

As illustrated in FIG. 5, information of a musical piece to be recommended to a user, which is output from the model, for example, is a numerical value representing a degree of recommendation for each musical piece, that is, for each musical piece ID (a vector of dimensions corresponding to the number of musical pieces). For example, the larger this numerical value, the higher the degree of recommendation. In addition, a numerical value of each musical piece ID output from combined layers (a numerical value of a table of an upper stage in FIG. 5), for example, may be converted such that addition of all the values become 1 so as to express a probability (a numerical value of a table of a lower stage in FIG. 5). This numerical value can be conceived as a probability of user's selection of a musical piece.

In an arithmetic operation using a model, the determination unit 12 may perform characterization (characteristics quantization) of each information input to the model, that is, falling the information into a characteristics space. As illustrated in FIG. 4, characterization of information is performed for each piece of information. The characterization is performed inside the model and can be performed similar to a conventional case. The characterization of a musical piece ID as an example will be described. First, the determination unit 12 inputs a musical piece ID and converts the musical piece ID into an N-dimensional vector V1 associated with the musical piece ID in advance (here, N is set in advance). Subsequently, the determination unit 12 converts the N-dimensional vector V1 into a characteristic quantity C1 that is a preset number of numerical values (that is, a vector of dimensions corresponding to a preset number). Each numerical value of a characteristic quantity C1 corresponds to a numerical value of a neuron in a neural network. Similar to a general arithmetic operation in a neural network, the conversion from a vector V1 to a characteristic quantity C1 is performed on the basis of a numerical value (a weighting factor) set at a connection between numerical values. A vector V1 associated with a musical piece ID and a weighting factor used for conversion from the vector V1 to the characteristic quantity C1 is generated through machine learning. In addition, the vector V1 at a start time point of machine learning is composed of a numerical value that is random. Characterization of the other information is also performed similar to that described above, and a characteristic quantity is acquired.

In addition, the characterization does not necessarily need to be performed. For example, information that is originally a numerical value (for example, current place information that is information representing latitude and longitude and information representing a remaining time up to a destination) may be used in the model without being characterized. In addition, also the other information may be converted into a form that is used in the model using a method other than the characterization.

The determination unit 12 inputs the characteristic quantity C1 of the musical piece ID to a recurrent neural network (RNN) included in the model. In addition, the determination unit 12 inputs a characteristic quantity C2 after a process in the RNN that is acquired through an arithmetic operation on an immediately preceding musical piece ID in a user's singing history (a characterization layer of a previous time) to the RNN. The determination unit 12 adds such characteristic quantities C1 and C2, thereby generating a characteristic quantity C3. The characteristic quantity C3 generated here is input to the RNN as the characteristic quantity C2 described above when an arithmetic operation is performed on a next musical piece ID in the user's singing history. In a case in which the input musical piece ID is a first musical piece ID in the user's singing history, an arithmetic operation on an immediately preceding musical piece ID is not performed, and thus, as the characteristic quantity C2, a characteristic quantity (for example, a characteristic quantity in which values of all the elements are 0) that has been set and stored in advance is used. By using the RNN in this way, output of information of a musical piece to be recommended to a user with the entire user's singing history including the order taken into account can be performed.

The determination unit 12 generates information of combined layers from information that has been input to the model and has been characterized. The information of the combined layers is acquired by simply horizontally combining (horizontally aligning each piece of information) respective pieces of information. Regarding information of a musical piece ID, as information of the combined layers, after all the musical piece IDs of a user's singing history are input, a characteristic quantity C′3 generated by the RNN is used.

As illustrated in FIG. 5, the determination unit 12 calculates information to be output from the information of the combined layers, that is, information of a musical piece to be recommended to a user. Similar to a general arithmetic operation in a neural network, this calculation is performed on the basis of numerical values (weighting factors) set in connection between numerical values. These weighting factors are generated using machine learning.

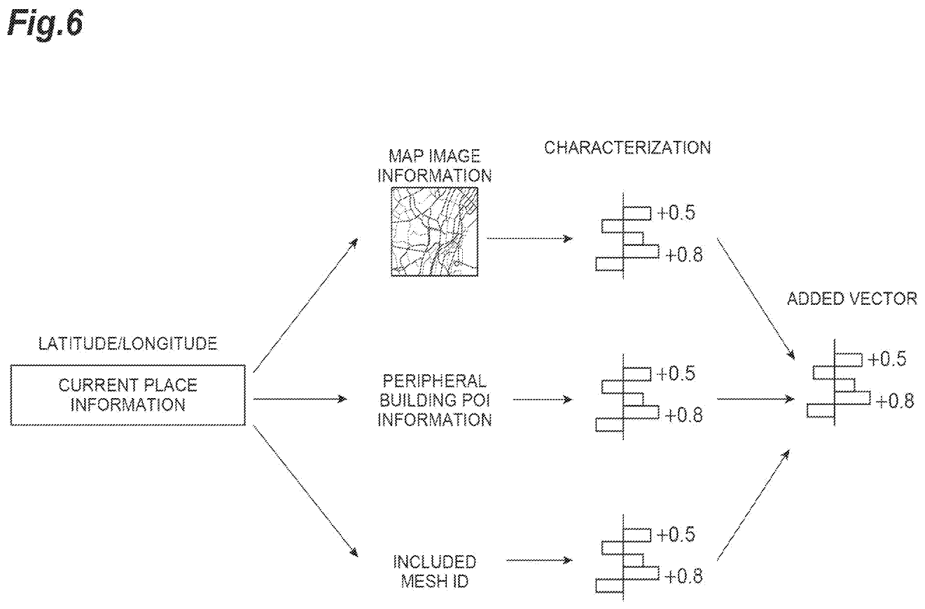

In addition, as illustrated in FIG. 6, current place information input to the model may be not the information representing latitude and longitude as described above but an image of a map corresponding to the current place acquired by the acquisition unit 11, information representing a POI corresponding to the current place, and a mesh ID of a mesh including the current place. In addition, as the current place information input to the model, all the information described above does not need to be used, and any piece thereof may not be included.

Each piece of information illustrated in FIG. 6 is characterized using a method similar to the method described above and becomes a characteristic quantity. In addition, in a case in which a plurality of pieces of information are used, characteristic quantities thereof may be added together. The added characteristic quantity is used as a characteristic quantity of the current place information illustrated in FIG. 4.

In addition, as information relating to a user's singing history input to the model, instead of or in addition to a musical piece ID of a musical piece sung by the user, other information relating to the musical piece sung by the user may be used. For example, meta information of a singer singing this musical piece, more specifically, information of any of an ID of the singer, age of the singer, gender of the singer, whether the singer is a group, and the number of released musical pieces of the singer may be used. Alternatively, meta information of this musical piece, more specifically, information of any of a lyric writer, a composer, whether or not this musical piece is played live, whether or not this musical piece is used in a drama, whether or not this musical piece is western music, and the like may be used. For example, in an internal data server of the recommendation system 10, such information may be stored in association with the musical piece (for example, a musical piece ID) and acquired as information input to the model on the basis of the musical piece.

Generation of the model using machine learning, for example, may be performed using such information of the past as learning data (teacher data). In such a case, regarding information of a musical piece to be recommended to a user, corresponding to an output, a numerical value of a musical piece ID of a musical piece that was actually sung next to a singing history of a user corresponding to an input is set to 1, and numerical values of musical piece IDs of the other musical pieces are set to 0. Machine learning is performed such that a musical piece to be recommended is optimized on the basis of each piece of information, and a musical piece to be recommended transitions in accordance with an input of a singing history. In addition, the generation of a model may be performed either by the recommendation system 10 or by a system (device) other than the recommendation system 10.

The model described above that is a learned model used in the recommendation system 10 is assumed to be used as a program module that is a part of artificial intelligence software. The model, for example, is used by a computer that includes a central processing unit (CPU) and a memory, and the CPU of the computer operates in accordance with an instruction from the model stored in the memory. For example, the CPU of the computer operates to input information to the model, perform an arithmetic operation according to the model, and output a result from the model in accordance with this instruction. More specifically, the CPU of the computer operates to input information to an input layer of a neural network, perform an arithmetic operation based on a learned weighting coefficient or the like in the neural network, and output a result from an output layer of the neural network in accordance with this instruction.

The determination unit 12 determines a musical piece to be recommended to a user on the basis of calculated information of musical pieces to be recommended to the user. For example, the determination unit 12 determines musical pieces of which numerical values represented in information of musical pieces to be recommended to a user are up to the N-th rank as musical pieces to be recommended to the user. Here, N is a numerical value that has been set and stored in advance.

In addition, when determining musical pieces to be recommended to a user, the determination unit 12 may exclude candidates of recommendation information on the basis of information representing a user's use history of musical pieces. For example, the determination unit 12 identifies singers singing musical pieces included in a user's singing history. The determination unit 12 excludes musical pieces (candidates of recommendation information) sung by singers other than this singer from musical pieces to be recommended to a user. For example, musical pieces of singers having no history are masked (excluded) from a table of a lower stage in FIG. 5. For example, the determination unit 12 stores a correspondence relation between a musical piece and a singer in advance and performs the exclusion process described above. In addition, a use history of musical pieces used for exclusion of musical pieces does not need to be a singing history and may be a history of musical pieces used by music applications other than karaoke (for example, musical pieces that have been listened to by a user). By filtering musical pieces on the basis of a history in this way, only musical pieces that are reliably sung by a user can be recommended.

The determination unit 12 outputs information of the determined musical pieces as recommendation information. For example, the determination unit 12 transmits the recommendation information to the user terminal 20 so as to be displayed. In addition, determination of musical pieces to be recommended to a user does not necessarily need to be performed as described above and may be performed on the calculated result. In addition, the output of information may be performed using a method other than that described above. Furthermore, determination of recommendation information may be performed by a method other than a method using a model generated using machine learning. The functions of the recommendation system 10 according to this embodiment have been described as above.

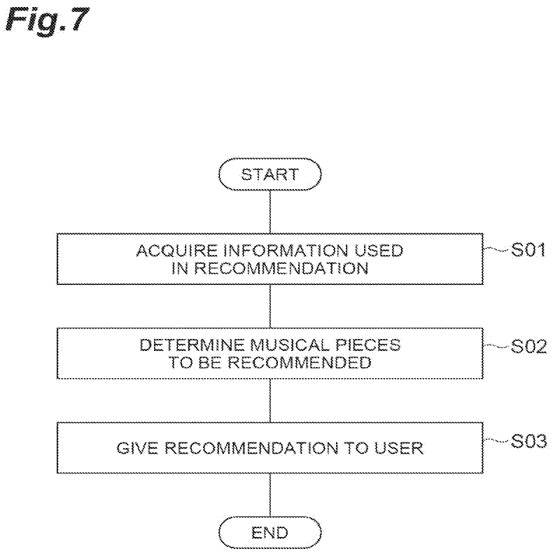

Subsequently, by using a flowchart illustrated in FIG. 7, a process performed by the recommendation system 10 according to this embodiment (an operation method performed by the recommendation system 10) will be described. In this process, information used for determining musical pieces to be recommended to a user is acquired by the acquisition unit 11 (S01). The acquired information includes information representing a remaining time of the use of a musical piece. In addition, this information may include the information described above other than that. The acquisition of information, for example, is performed by receiving information transmitted from the user terminal 20.

Subsequently, by using the determination unit 12, a model stored in advance is used, and information of musical pieces to be recommended to a user is calculated from the information acquired by the acquisition unit 11. For example, this information is a probability of a user's selecting a musical piece. Musical pieces to be recommended to a user are determined on the basis of the calculated information by the determination unit 12 (S02). Subsequently, a recommendation of the musical pieces determined by the determination unit 12 is given (S03). For example, the recommendation is given by transmitting information of the determined musical pieces to the user terminal 20 as recommendation information. The user terminal 20 receives the recommendation information and performs output thereof such as display or the like. A user can determine a musical piece to sing by referring to this information. The process performed by the recommendation system 10 according to this embodiment has been described as above.

In this embodiment, in determination of recommendation information, information representing a remaining time of the use of a musical piece is used. For example, as described above, information representing a required time up to a destination is used. Thus, according to this embodiment, a recommendation relating to musical pieces to be used by a user can be appropriately given in accordance with a remaining time.

In addition, as in this embodiment, a place at which a musical piece is used, for example, as described above, information representing a current place of the vehicle may be used for the recommendation. According to this configuration, a recommendation of musical pieces according to the place can be given. For example, a recommendation of musical pieces with a current place of the vehicle such as a coastline or a highway being taken into account can be given. More specifically, in a case in which the vehicle is running along a coastline, popular songs relating to summer or the sea can be recommended.

In addition, as information representing a place at which a musical piece is used, an image (for example, an image of a map) corresponding to the place may be used in a recommendation. Alternatively, as information representing a place at which a musical piece is used, information representing a POI corresponding to the place may be used in a recommendation. According to this configuration, a recommendation with a topography of a place at which a user is present taken into account or with a nearby landmark taken into account can be given.

In addition, as in this embodiment, information representing a destination of a user using a musical piece may be used in a recommendation. According to this configuration, a recommendation of musical pieces according to a destination of a user can be given. For example, in a case in which the sea, a snowing mountain, or the like is set as a destination, a recommendation of musical pieces relating thereto can be given. Alternatively, in a case in which a baseball ground is set as a destination, a recommendation of musical pieces of baseball or sports can be given. In this way, by using the information as described above in a recommendation, a recommendation of musical pieces according to a surrounding background and a scene can be given. However, information of a place at which a musical piece is used and information representing a destination of a user using the musical piece may not be used in a recommendation.

In addition, information representing a user's use history of musical pieces may be used in a recommendation. According to this configuration, a recommendation of musical pieces with a preference and a singing trend of a user for musical pieces taken into account can be given. Furthermore, recommendation information may be determined by excluding candidates of recommendation information based on information representing a user's use history of musical pieces. According to such a configuration, a more appropriate recommendation can be given. For example, as described above, only musical pieces that user reliably sings can be recommended. However, the information representing a user's use history of musical pieces may not be used in a recommendation. In addition, information other than the information described above may be used in a recommendation as long as it can be used for giving an effective recommendation relating to used musical pieces to a user.

In the embodiment described above, although a recommendation relating to musical pieces at the time of performing karaoke inside a vehicle has been described as an example, a recommendation inside a vehicle does not need to be premised, and a recommendation relating to musical pieces may be given in a case in which a remaining time of the use of a musical piece is known. For example, it may be applied to a case in which a recommendation relating to musical pieces is given in a case in which an end time is set at a karaoke parlor.

Each block diagram used for description of the embodiment described above illustrates blocks in units of functions. Such functional blocks (component units) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire or wirelessly) connecting two or more devices separated physically or logically. A functional block may be realized by one device or a plurality of devices described above and software in combination.

As functions, there are deciding, determining, judging, computing, calculating, processing, deriving, inspecting, searching, checking, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like, and the functions are not limited thereto. For example, a functional block (constituent unit) enabling transmission to function is referred to as a transmitting unit or a transmitter. As described above, a method for realizing all the functions is not particularly limited.

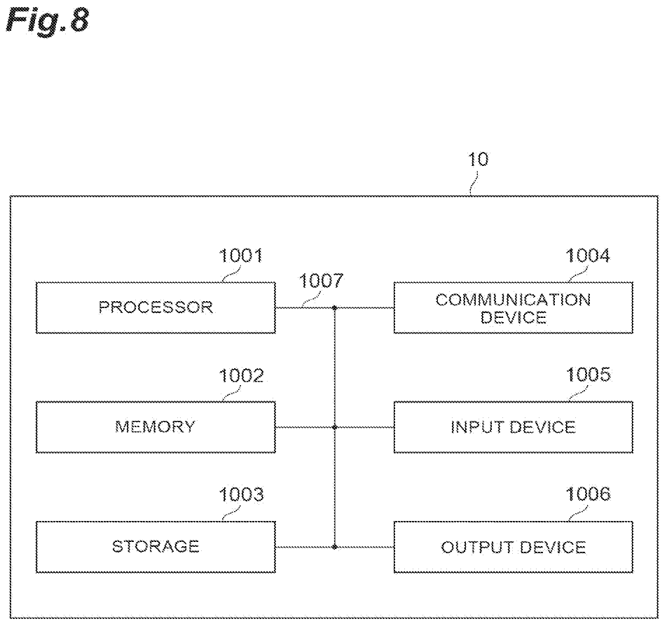

For example, the recommendation system 10 according to an embodiment of the present disclosure may function as a computer that performs information processing of the present disclosure. FIG. 8 is a diagram illustrating an example of a hardware configuration of the recommendation system 10 according to an embodiment of the present disclosure. The recommendation system 10 described above, physically, may be configured as a computer device including a processor 1001, a memory 1002, a storage 1003, a communication device 1004, an input device 1005, an output device 1006, a bus 1007, and the like. In addition, the hardware configuration of the user terminal 20 and the in-vehicle terminal 30 may be that described here.

In addition, in the following description, a term “device” may be rephrased as a circuit, a device, a unit, or the like. The hardware configuration of the recommendation system 10 may be configured to include one or a plurality of devices illustrated in the drawing and may be configured without including some of these devices.

Each function of the recommendation system 10 may be realized when the processor 1001 performs an arithmetic operation by causing predetermined software (a program) to be read onto hardware such as the processor 1001, the memory 1002, and the like, controls communication using the communication device 1004, and controls at least one of data reading and data writing for the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like. For example, each function of the recommendation system 10 described above may be realized by the processor 1001.

In addition, the processor 1001 reads a program (program code), a software module, data, and the like from at least one of the storage 1003 and the communication device 1004 into the memory 1002 and executes various processes in accordance with these. As the program, a program causing a computer to execute at least some of the operations described in the embodiment described above is used. For example, each function of the recommendation system 10 may be realized by a control program that is stored in the memory 1002 and operated by the processor 1001. Although the various processes described above have been described as being executed by one processor 1001, the processes may be executed simultaneously or sequentially by two or more processors 1001. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable for performing the information processing according to one embodiment of the present disclosure.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium included in the recommendation system 10, for example, may be a database including at least one of the memory 1002 and a storage 1003, a server, or any other appropriate medium.

The communication device 1004 is hardware (a transmission/reception device) for performing inter-computer communication through at least one of a wired network and a wireless network and, for example, may be called also a network device, a network controller, a network card, a communication module, or the like.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the recommendation system 10 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

The input/output information and the like may be stored in a specific place (for example, a memory) or managed using a management table. The input/output information and the like may be overwritten, updated, or added to. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be individually used, used in combination, or be switched therebetween in accordance with execution. In addition, a notification of predetermined information (for example, a notification of being X) is not limited to being performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set in accordance with the claims. Thus, the description presented in the present disclosure is for the purpose of exemplary description and does not have any limited meaning for the present disclosure.

It is apparent that software, regardless of whether it is called software, firmware, middleware, a microcode, a hardware description language, or any other name, may be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received via a transmission medium. For example, in a case in which software is transmitted from a website, a server, or any other remote source using at least one of a wiring technology such as a coaxial cable, an optical fiber cable, a twisted pair, a digital subscriber line (DSL) or the like and a radio technology such as infrared rays, microwaves, or the like, at least one of such a wiring technology and a radio technology is included in the definition of the transmission medium.

Terms such as “system” and “network” used in the present disclosure are interchangeably used.

In addition, information, a parameter, and the like described in the present disclosure may be represented using absolute values, relative values with respect to predetermined values, or other corresponding information.

Terms such as “determining” used in the present disclosure may include various operations of various types. The “determining”, for example, may include a case in which judging, calculating, computing, processing, deriving, investigating, looking up, search, and inquiry (for example, looking up a table, a database, or any other data structure), or ascertaining is regarded as “determining”. In addition, “determining” may include a case in which receiving (for example, receiving information), transmitting (for example, transmitting information), input, output, or accessing (for example, accessing data in a memory) is regarded as “determining”. Furthermore, “determining” may include a case in which resolving, selecting, choosing, establishing, comparing, or the like is regarded as “determining”. In other words, “determining” includes a case in which a certain operation is regarded as “determining”. In addition, “determining” may be rephrased with “assuming”, “expecting”, “considering”, and the like.

Terms such as “connected” or “coupled” or all the modifications thereof mean all the kinds of direct or indirect connection or coupling between two or more elements and may include presence of one or more intermediate elements between two elements that are mutually “connected” or “coupled”. Coupling or connection between elements may be physical coupling or connection, logical coupling or connection, or a combination thereof. For example, “connection” may be rephrased with “access”. When used in the present disclosure, two elements may be considered as being mutually “connected” or “coupled” by using one or more wires and at least one of a cable and a print electric connection and, as several non-limiting and non-comprehensive examples, by using electromagnetic energy such as electromagnetic energy having wavelengths in a radio frequency region, a microwave region, and a light (both visible light and non-visible light) region.

Description of “on the basis of” used in the present disclosure does not mean “only on the basis of” unless otherwise mentioned. In other words, description of “on the basis of” means both “only on the basis of” and “on the basis of at least.”

In the present disclosure, in a case in which names such as “first”, “second”, and the like is used, referring to each element does not generally limit the amount or the order of such an element. Such names may be used in the present disclosure as a convenient way for distinguishing two or more elements from each other. Accordingly, referring to the first and second elements does not mean that only the two elements are employed therein or the first element should precede the second element in a certain form.

In a case in which “include,” “including,” and modifications thereof are used in the present disclosure, such terms are intended to be inclusive like a term “comprising.” In addition, a term “or” used in the present disclosure is intended to be not an exclusive logical sum.

In the present disclosure, for example, in a case in which an article such as “a,” “an,” or “the” in English is added through a translation, the present disclosure may include a plural form of a noun following such an article.

In the present disclosure, a term “A and B are different” may means that “A and B are different from each other”. In addition, the term may mean that “A and B are different from C”. Terms “separated”, “combined”, and the like may be interpreted similar to “different”.

### REFERENCE SIGNS LIST

10 Recommendation system
11 Acquisition unit
12 Determination unit
20 User terminal
30 In-vehicle terminal
1001 Processor
1002 Memory
1003 Storage
1004 Communication device
1005 Input device
1006 Output device
1007 Bus

1. A recommendation system determining recommendation information used for giving a recommendation relating to musical pieces to be used to a user, the recommendation system comprising circuitry configured to:
acquire information representing a remaining time of use of a musical piece; and
determine the recommendation information on the basis of the acquired information acquired by the acquisition unit.

2. The recommendation system according to claim 1, wherein the circuitry acquires information representing a place at which a musical piece is used.

3. The recommendation system according to claim 2, wherein the circuitry an image corresponding to a place as the information representing the place at which a musical piece is used.

4. The recommendation system according to claim 2, wherein the circuitry acquires information representing a POI corresponding to a place as the information representing the place at which a musical piece is used.

5. The recommendation system according to claim 1, wherein the circuitry acquires information representing a destination of a user using a musical piece.

6. The recommendation system according to claim 1, wherein the circuitry acquires information representing a user's use history of musical pieces.

7. The recommendation system according to claim 6, wherein the circuitry determines the recommendation information by excluding candidates of the recommendation information on the basis of the information representing a user's use history of musical pieces.

8. The recommendation system according to claim 3, wherein the circuitry acquires information representing a POI corresponding to a place as the information representing the place at which a musical piece is used.
